(19) United States
(12) Patent Application Publication
(10) Pub. No.: US 2014/0320391 A1
(43) Pub. Date: Oct. 30, 2014

(54) METHODS FOR IMPROVEMENTS IN MOBILE ELECTRONIC DEVICES

(71) Applicant: GAURAV BAZAZ, EDGEWATER, NJ (US)

(72) Inventor: GAURAV BAZAZ, EDGEWATER, NJ (US)

(21) Appl. No.: 14/142,740

(22) Filed: Dec. 27, 2013

Related U.S. Application Data
(60) Provisional application No. 61/747,101, filed on Dec. 28, 2012.

(51) Int. Cl. H04W 52/02; G06F 3/041; G06F 3/01; G06F 3/0481; G01C 21/36; G06F 3/0484; G06F 3/0488; G06F 9/30; G06F 9/54; H04M 1/725; H04W 12/08

(52) U.S. Cl. CPC H04W 52/0277; H04M 1/72577; H04M 1/72569; H04M 1/72563; G06F 3/041; G06F 3/017; G06F 3/0481; H04W 12/08; G06F 3/04842; G06F 3/0488; G06F 9/30145; G06F 9/542; G01C 21/3652
USPC 345/156; 455/574; 455/414.1; 715/863; 455/411; 712/220; 719/318; 701/532

(57) ABSTRACT

A series of methods are presented to improve the operation and user experience of mobile handheld devices such as mobile phones. The methods include methods allowing useful operation on low battery levels, touch input from non-conventional models, stored procedures for executing series of actions, application management, navigational communication through vibratory motions, among others.

### RELATED APPLICATION

This application claims the benefit of priority to U.S. Provisional Application 61/747,101 filed 28 Dec. 2012, the entire disclosure of which is incorporated by reference.

### FIELD OF INVENTION

The present invention relates to handheld electronic devices such as mobile phones and tablets.

### BACKGROUND

Mobile phones are one of the most common electronic devices in the modern world. These phones no longer serve as plain wireless telephone devices but as small handheld computers. The devices offer a series of different applications and use cases and are used by over a billion people globally. However, there are various aspects of the design and operation of these devices that can be considerably improved for greater efficiency, security and better user experience.

### SUMMARY OF INVENTIONS

We present a series of inventions that offer methods for improvement in the operation and use of mobile phones. In addition, we describe a single embodiment of each invention, wherein the embodiment is indicative and exemplar of the invention, but not restrictive in design or implementation.

A method is proposed to allow multiple users to actively use the same mobile phone in parallel, with only one user using it at a given time, but multiple users using the same device over a period of time. All user specific data including applications, information, contact lists, application data and other such data items are separated so that each user only has access to his or her information, and doesn't have access to other users' information. In addition, the users can share the same phone number.

The operating system of the phone provides a profile management system which allows the creation of multiple profiles on the same phone. Each profile is associated with one user. All data that can possibly be split across multiple users, is associated with a specific profile. A common user profile is also provided, wherein the data associated with this user is available to all users. Additionally, a Super-user profile is also provided, wherein, such user has access to all users' data, and direct access to all the devices data, but all other users do not have access to this user's profile.

Whenever any data is created on the device, whether calling records, voicemails, contact information, application downloads, notes, searches, music downloads or any other piece of data, it is associated with the current user under whose profile the data was created. When the user tries to access any piece of data, the operating system limits the user's view to the data associated with that user's profile alone. The data of different users may be saved in the same locations on the storage media on the phone, but since it is logically separated through profile association, each user only has access to his own data.

The users can access their profile by authenticating themselves to the device using any conventional authentication method such as password, face recognition, gesture recognition etc. Once authenticated, the OS of the device will load the profile of that user, with UI and data specific to that user's profile.

A method is provided to limit the operation of the device when it has very low battery levels to the bare minimum operating requirements. In order to prevent the phone from switching off from a lack of power supply, the system will detect when the battery energy level is low, and automatically switch off all non-essential functions. The set of essential function allowed may be pre-defined in the device or selected by the user or a combination of both. This method prevents energy being used by non-essential processes, in the background or as part of standard user operation. Some essential function that may be allowed with weak batteries might be functions such as ability to send and receive SMS messages, ability to make phone calls, and ability to run mapping application. In addition, some operations may be operated at low energy levels. For instance the screen may be switch to black and white mode and/or low resolution mode in order to reduce processing load on the microprocessor. Additionally, a sliding scale approach may be used, wherein, different levels of battery power allow different number of device components to function and also operate them at different power levels. Therefore, as battery energy goes down, sequentially device components may be shut off, with each component prioritized for switch-off based on a combination of factors including importance, energy consumption etc. Therefore a component with high energy consumption and limited importance will be switched off first. The device may maintain a dynamic list of components prioritized by their switch off points.

Additionally, some components may be operated at lower power levels when energy available reduces. For example, amplifiers may be run at lower power, which might degrade user experience but conserve power. Non-essential sensors such as digital compass, accelerometers, humidity sensors may be switched off or their standby mode be reduced to a very low power state. Interface components such as Wi-Fi transceivers may also be switched off at some point to conserve power. However, essential functions such as phone calling and SMS messages may be preserved until the device runs out of power. The key innovation is following a priority list of components based on which components are switched off as energy available reduces, where the placement of components on the priority list is determined by an algorithm or customized by the user.

An apparatus and method are provided to allow the user to use a larger surface area of the portable electronic device for entering user inputs. In one model, a touch sensitive surface is provided on the back side of the phone (surface opposite to the surface with the screen). The user can enter inputs on the rear of the phone while enjoying full screen views on the front side. The user may be able to enter scrolling instructions, action instruction during gaming applications and also possibly keyboard style typing to write text.

In order to make it easier for the user to enter instruction correctly, a UI element may be displayed on the screen to identify the current finger position on the touch surface on the back side, relative to the screen, to the user. The UI element may be something akin to a dot that traces the current location of the user's finger tip on rear of the device relative to the screen in front.

A method is proposed for allowing a sequence of actions to be performed by the device when a pre-defined gesture is executed by the user using a touchscreen input interface or a call for execution is made by the user through some other input interface. The sequence of actions would be a set of actions a user often performs on the device, but requires the user to make multiple inputs into the system. As proposed herein, the set of actions would be automatically performed by the device when the user enters a command for the sequence of actions to be performed. The command to execute the series of action would be entered directly from the operating system (OS) user interface of the device, as an OS level service, without requiring the user to enter any application on the device. For instance, a user may be setting an alarm every night for 7 am. The process of setting the alarm would generally require the user to find the alarm application on his device, open the alarm application, set the time for the alarm, or if pre-set, find the 7 am alarm, and finally switch it on. As proposed by current invention, the user would click an icon or enter a command or click an icon to enter a command which would execute all these steps automatically for the user. So after the user enters the command, the alarm for 7am next day would be set. Similarly, if the user is travelling the user may want to update his family about his location. Currently, the user may open the SMS application, enter text identifying his current location and send the text. As proposed by current invention, the user may enter a command on the main screen and the system would automatically find the user's current location from the on-device GPS, call the SMS application, add the relevant recipients—such as the user's family—add the current location as the text for delivery and send it. The specific set of actions would not be pre-defined in the system, but would be recorded by the users based on their own requirements.

The sequence of actions to be performed by the system will be set by the user before the given command is ever used. The user will set the sequence of steps by ‘recording’ the steps. This may be implemented in the following way, though other models may be used: (a) the user will call the auto-execution service from the OS by some method provided by the OS, such as clicking on an icon. Once called, the user will call the auto-execution service to record the series of steps. This may be done again through a method provided by the system, such as clicking an icon. Once the record action is called, the user will then return to the OS user interface screen and start entering the sequence of steps he wants recorded. For instance, for the alarm auto-execution process, the user will find the alarm application, open it, set the alarm time to 7 am, and turn the alarm on. Once done with the sequence, the user will call the auto-execution record process to be stopped. At this point the steps to be executed by the device will be stored in the auto-execution process, and when the user enters the command for the specific action to be called, the sequence of steps would be called and executed.

The user would be able to store multiple auto-execution processes in the device at any given time. Also, the user can call the auto-execution process directly from the home screen by making a gesture or clicking an icon or through other input methods. The invention may also be implemented, by requiring the user to open an application through which all the auto-execution process commands are made available, through a simple interface. This may include a list of auto-execution processes available, a button to call the record process, a method for removing and editing existing auto-execution processes etc.

A method is proposed for providing an intelligent wallpapers system for mobile and small screen devices. Existing wallpapers are static images that provide the background to the operating system user interface of the device. As proposed herein, an intelligent wallpaper is a dynamic image that modifies itself based on various possible parameters. The parameters that control the behavior of the dynamic image maybe actions such as motion of the device, number of voicemails pending, local temperature etc. Primarily, the intelligent wallpaper may convey some type of system information to the user or change itself dynamically in an aesthetically pleasing way. The intelligent wallpaper may therefore serve a purpose of utility or entertainment. In one embodiment, the intelligent wallpaper would consist of images of some objects such as balls that bounce around the screen when the user moves the device.

A method and apparatus for communicating real-time directions to the user, while navigating, is provided. Most mobile devices currently have built-in GPS systems. The GPS can be used to locate the device globally and also provide directions to the user for going from one point to another point. Conventional devices provide the directions either on-screen or through an audio output, wherein, a machine generated voice communicates the directions to the user as the user moves. An alternative method for communicating directions to users is provided herein, whereby the phone executes different types of vibratory motion to communicate which direction the user needs to turn. One type of vibratory motion would communicate a left turn, another would communicate a right turn, and another may communicate a U-turn. Similarly, another set of motions may be executed for bearing left or bearing right or other possible directions. The vibratory motion would be useful for the user when requiring navigation while walking. The user can hold the device in his or her hand and get navigational information without having to look at the screen while walking and also without relying on audio which is not practical when the user is walking. The various vibratory motions may vary in their amplitude, frequency or component frequencies, so that user can easily learn which type of navigational action each motion communicates.

A method is provided for allowing users to communicate their phone availability status to other people in their network or any other person trying to call them over the phone network. The system would allow other users who have the service available to know if the person they are trying to call is likely to accept their call or not, and decide to call accordingly. The system would require support at the network level, so that the status of each user can be communicated to others on the network. The underlying network which carries the user's status information may be the phone network or another network such as the internet. The user may set his or her status as “available”, “busy”, “unavailable”, “call back”, “available after 5 pm” or any other message. When another user whose phone device or application supports the Phone Status service wants to call the first person, she will open the phone application and can see the status of the person she wants to call. Accordingly, she can decide to proceed with the call or wait.

A method is provided for controlling the lighting of screens on mobile/small screen devices. In conventional mobile devices, screens are switched off when the device is interpreted to not be in use, so that battery energy can be conserved. The method generally used by the device to determine if it's not in use, is to monitor inputs into the device. If the user is making inputs into the device, through a keyboard, physical buttons or touchscreen or other input methods, then the device is determined to be in use. The devices generally have a fixed or dynamic time length for which the screen of the device is kept lighted after the device has received its last input. There might be some other methods that may also be used by the device to determine if the device is in use or not. The invention described herein proposes an additional method that can help determine if the device is still in use or not. Oftentimes with modern web enabled mobile and small screen devices, the user is often reading long text passages on the screen. While the user is reading the passages, there is no input from the user and also there may not be any activity with the application in use. Nevertheless, the device is still in use as the user is reading. Therefore, the device may not be able to use the existing methods to determine if the device is in use or not and keep the screen lighted.

The alternative method proposed herein uses the user facing camera on the mobile device to determine if the user is using the device and keep the screen lighted. As proposed herein, when the conventional methods determine the device to not be in use and signal that the screen should be lighted down, the user-facing camera on the device, if it has one, will be switched on. The camera will take a snapshot image in its view field and using face recognition technology, check if the user is looking at the device. If the face recognition technology determines that the user is looking at the device and therefore, most likely using the screen, it will determine that the device is still in use, and signal for the screen to not be lighted down.

A method is proposed to help users manage the applications that they have downloaded to their mobile devices such as cellphones, mp3 players and tablets. Oftentimes, users download a very large number of applications, but only use a few. Also they find it hard to find the appropriate applications for their use and how they have been using their applications to decide which they want to keep and which ones to delete. We propose a method wherein an OS level service analyzes the applications downloaded to the device and determines usage statistics such as how often an application is opened, how long it is used etc. This information can be compiled into an index which the device owner can check whenever he needs to. Based on the usage statistics, the user can determine which applications to keep and which ones to delete. The system may also automatically mark some applications for deletion based on the usage information. For instance, if some applications are found to not have been used at all for a very long time, the system may set the applications for auto-delete and notify user to get permission to delete them. This would allow the device to reduce system resource usage such as reducing hard drive memory usage without requiring the user to manually keep track of their application storage.

A method is proposed to allow user to protect access to individual applications installed on a mobile device at the Operating System level. While existing applications allow password protection of the applications, availability of password protection is dependent on the specific application offering user the option to do so. As proposed herein, the Operating System of the device offers user the option of locking the application behind an authentication system independent of whether the application itself offers the option or not. Therefore, if the user wants to place an application behind authentication protection, the device OS will offer an authentication layer on top of the application, which prevents access to the chosen application unless the authentication step is passed. The passkey will be set through calls to an underlying OS authentication service, wherein the user will select the application to place behind authentication protection, set the passkey such as a password, image, gesture, facial image etc. and also delete the protection when needed. An additional layer of authentication may be required to allow the user to control the process.

### DESCRIPTION OF DRAWINGS

FIG. 1 describes a model for allowing a mobile device to sequentially reduce its power consumption by lowering or switching the power supply to components within the device based on user controlled criteria. The order in which components 001 are powered down will be controlled by the user, so components are powered down based on user preferences. As energy level in the device battery reduces, the power management system of the device will check the priority score 002 on this table to decide which components to power down. The components with a low priority score will be powered down first, while those with a higher score will be powered down later. The current status of the component may also be displayed in the table of FIG. 1 in column 004.

FIG. 2 shows a physical model of a cellphone device in different perspectives. In FIG. 2 section (a) we see the front side of the device 005 with a front body 010 and a physical control button 011. The device also has a screen 006 on the front end with some graphical elements 008 displayed on it. The screen 006 of the device maybe a touchscreen system where the user can interact with the device by touching the screen at different points and executing certain motions. Graphical elements 008 are displayed on the screen and may perform certain actions. FIG. 2 section (b) shows the back side of the same device. The backside body 013 also has a touch-sensitive area 015. The user can touch this area 015 in different points and execute different touch motions to interact with the device. FIG. 2 section (c) provides a side-view of the same device. We can see the back side body 013 with the touch-sensitive area 015 as well as the side edge 017. The side edge 017 has a touch sensitive area 020. The user can interact with the device by touching and executing motions on the side touch sensitive area 020. In FIG. 2 (d) we see the device from the side perspective from the opposite side. The side edge 022 has a touch-sensitive area 024. The user can interact with the device by touching and executing motions on this area 024. In a given embodiment any one or more than one of the faces or edges of the device may be enhanced with touch-responsive surfaces which can be used as an input mechanism. Compared with existing devices which provide buttons as input mechanisms, this model provides touch sensitive surfaces, which correspond to cursor motions on the video screen, as an input mechanism. This allows a more capable and user friendly mode of input.

FIG. 3 section (a) shows a method of implementation of the auto-execution system for mobile devices. The process starts at 026. The user starts recording the steps for auto-execution at 028. If the recording is complete at 030, the user ends the recording process at 032 else continues recording the actions to be re-executed automatically at a later time. The user can execute the start record and end record actions through an interface on the device which manages the action recording process. FIG. 3 section (b) shows a cellphone device 034 with a control button 036. The device has a screen 040 which shows various graphical elements. A general menu 038 is displayed at the bottom. A header 046 at the top shows the caption of application currently running. The application currently run is used to record and execute auto-execution procedures, therefore the caption displays the title accordingly. Below the header 046, a section header 044 indicates the nature of information displayed underneath. Beneath the section header 046 we see a set of menu items that show various previously stored auto-execution procedures such as 042. The user can select one of these procedures and execute them or edit them. On execution, they will automatically run a set of actions that were previously recorded by the user. FIG. 3 section (c), an auto-execution sequence 042 from FIG. 3 section (b) has been selected and its details are being displayed. A graphical element 050 shows the name of the auto-execution sequence selected. Below the graphical element 050 we see a series of single actions 048 which form part of this auto-execution procedure. Each of these steps has been recorded by the user at a previous time. The user can edit these steps if needed. When this auto-execution procedure is called by the user, all the steps shown here will be executed by the system automatically in sequence. FIG. 3 section (d) shows an interface for calling the auto-execution procedures quickly and easily. Instead of opening a new application on the device, the user can click an icon 052 which displays a dropdown list 054 of possible auto-execution procedures such as 056. Each possible procedure 056 may be displayed by a name or an icon representing it which may be chosen by the user or by the system automatically. The user can click one icon from the list of icons 056 and get it executed. In another model as shown in FIG. 3 section (e), the user can call an auto-execution procedure directly by entering a symbol on the screen. In this case the user clicks an icon 058 on the screen which opens up a canvas type area 060 on the screen. The user can draw a symbol 062 on this canvas area 060. The symbol is associated with a specific auto-execution procedure, which is called when the user draws the symbol on the canvas 060. The auto-execution procedure may be any series of steps such as setting an alarm for a specific time, making a phone call to a specific number. Sending a specific SMS messages to specific contact or contacts, changing a device setting such as wallpaper or setting Wi-Fi connectivity to a different setting etc. In FIG. 3 section (f) the user draws a different icon 064 on the same canvas 060.

FIG. 4 shows how a navigational feedback system using vibratory motion of the device may be implemented. In FIG. 4 section (a) we see a left pointing arrow 065 at the top indicating that the device is supposed to communicate a left turn to the user. The device vibrates at a specific frequency executing a distinct vibratory motion as indicated by the waveform in chart 067. In FIG. 4 section (b) the arrow 068 at the top indicates that the device needs to communicate a turn to the right. The device in this case executes a vibratory motion of a different frequency and pattern as shown by the waveform in chart 070. Similarly, in FIG. 4 section (c), the device needs to communicate a U-turn as shown by the arrow 072. The device executes a vibratory motion of a different pattern as shown by the waveform in chart 074. In each case the vibratory motion of the device can be of a different pattern, varying in frequencies, amplitudes, periods etc. More complex vibratory motions such as those consisting of multiple frequencies mixed together are also possible. Most importantly, each motion is clearly distinct from every other and the user can easily identify which navigation action it signifies. When the user is holding the device and walking, the device will execute the required vibratory motion when a navigational direction needs to be communicated to the user. The user will sense the vibratory motion and translate it into the appropriate action. In this manner, the navigational information will be communicated from the device to the user. The mechanism to execute the vibratory motion may be provided by the underlying device operating system, and called by any navigational application on the device. It may also be built into the application itself and executed through application programming interfaces provided by the operating system.

FIG. 5 shows a cellphone device 076 with a control button 078. The display screen 079 on the device shows graphical elements for interaction. The top of the screen carries a header block 080 which indicates the nature of the information being displayed. The screen currently is showing a list of contacts. Various graphical blocks on the display such as 082 show information about individual contacts. The name 084 of the contact is displayed at the top followed by the phone number 089. Below the phone number a graphical element 085 displays whether or not the user is currently available to accept phone calls through an icon along with text 094 which indicates the same information, communicating that the user is ‘not available’. In the next contact block, similarly, the icon 090 and text 087 indicate that the user is ‘busy’ for phone calls and therefore should probably not be called. In the next block, the icon 092 and the text 093 indicate that the user is available and can be called.

FIG. 6 section (a) shows a decision logic flow for a conventional system for dimming or switching the device screen off. This shows the logic for the current conventional devices. The process starts at 096. At 098 the system checks if the amount of time since the last input from the user has exceeded a certain limit. This is used to determine if the user is still using the device or is no longer interacting with the device. If the system finds that the amount of time since the last input has not exceeded the limit, it will wait and check again later. However, if the system finds that the time passed is greater than the limit it will dim the screen at 100. The system then checks for the time lapse since last input again, but against a different larger limit at 102. If the time lapse since last input is less than this larger limit, it will continue to check for the time lapse periodically. However, if the time lapse is larger, the system will switch the device screen off at 104.

FIG. 6 section (b) shows a decision logic flow for a new camera based system for dimming or switching the device screen off. The process starts at 106. At 108 the device checks it the time lapse since the last input is greater than a certain limit. If it is not larger than the limit, then the system waits and checks again at a later time. However, if the system finds that the time lapse since last input is greater than the given limit. it will switch on the user facing camera on the device at 113 and take a snapshot or video of the user for a brief time at 120. Using the data captured from the camera regarding the user, the system will determine if the user is still using the device or not at 118. The system will try to judge if the snapshot or video from the camera shows the user looking at the screen or not. If the user is determined to be looking at the screen, then he is most likely using it and the screen should be kept on and the system goes back to 112 where it now checks not only the time lapse since last input but also the time lapse since last camera check. If the time since last camera check is below a certain limit, no action will be taken except waiting for another periodic time lapse check. If however, the time lapse since last camera check is above the limit, a camera check is run again. On the other hand, if the user is determined to not be looking at the screen anymore at 118, the screen can be dimmed or switched off, as shown at 116.

FIG. 7 shows a simplified logical flow for a system for managing applications on a smartphone device which supports multiple applications that can be installed on the device. The process starts at 121. The system collects usage information for all applications on the system as shown at 122. Using the information collected the system calculates the Usage Index for the device which measures the value of each application to the user by measuring application information across multiple criteria. The index may look into factors such as frequency of use, duration of use each time, time and place of use, size of application, type of application, among other items. It may also use information about application from a central database which may hold information such as the average user rating of the application, its usage information across devices, its ratings or importance level as determined by some experts etc. The system will gather all different pieces of information across parameters and using an algorithm calculate the Usage or Value index for each application as shown at 124. The system will then make this information available to the user at 126. It will also select application with usage index value below a given threshold at 128. These applications are determined to be of little value to the user as the user is not using them much and they may be consuming valuable resources on the device which can be freed up. The applications that the system determines to be below the given limit will be set for deletion by the system at 130. Next, at an algorithmically determined time the system will notify the user that certain applications have been marked for deletion from the system and will ask the user permission to go ahead with the deletion, allowing the user to select and deselect applications for deletion from the list in the notification. This is shown at 132. If the user gives permission for deletion, the system proceeds to delete the selected applications from the device at 134.

FIG. 7 section (b) shows an interface for a system that manages applications installed on a smartphone device. The smartphone device 137 with a control button 138. The display screen 150 on the device shows a set of graphics that form the user interface for the system. the header block 140 shows the header for the screen indicating the nature of the application and information on the screen. Various graphical blocks on the screen such as 142 display the usage information for various applications installed on the device. The name of the application 144 is shown at the top of the block 142. Below the application name 144, various elements of information about the application are displayed at 146. The Usage Index score for the application is also displayed at 148. In this embodiment, a low score indicates a poor rating and high score indicates a good rating. Similarly, we see blocks for other applications installed on the device with their descriptive information and Usage Index scores.

FIG. 7 section (c) shows the notification from the application manager system to the user for deleting applications with low Usage Index scores. The notification 152 has a header 159 which indicates that the notification is from the Application Manager system. An explanation text 154 below the header 159 provides some background information to the user about the notification. Below the text 154, a list of applications 156 is presented which notes the applications marked for deletion. The user can deselect some or all of these applications and then click the ‘ok’ button 158 on the screen. Once the user clicks the ‘ok’ button 158, the applications selected for deletion are deleted from the system and the resources used by those applications are freed for use.

FIG. 8 shows the logical flow for an operating system level module for authentication protection of applications installed on a mobile electronic device. FIG. 8 section (a) shows a simplified process flow for the launch of an application installed on a smartphone device with no authentication requirement. The process starts at 160. The user selects an application to launch at 162 through the interface provided by the operating system of the device. Once the user has selected the application to be launched, the operating system issues the commands that launch the application on the operating system at 164 and the application is launched at 166. FIG. 8 section (b) shows a simplified flow for a system where individual applications installed on an operating system of a smartphone device can be authentication protected by the user through the operating system, even if the application itself provides no authentication protection. The process starts at 168. The user selects an application to launch at 170 through the interface provided by the operating system. At this point the operating system checks if the chosen application is authentication protected by the user at 172. If it isn't the operating system launches the application at 178. If it is authentication protected, the operating system will ask the user for the password or some equivalent authorization or verification input such as secret voice, image or touch inputs at 174. If the user passes the verification test at 176, the application is launched at 178. If the user fails the verification test, the system may provide the user additional attempts to pass the test up to a certain limited number of attempts, failing which the application will not be launched. If the user fails the verification, the system checks number of attempts at 180. If the number of attempts is not above a given limit, the user is given another chance to pass the verification at 174. If however the number of attempts is above the limit, the system will not launch the application and exit the launch process at 182. The system may execute some exit procedures such as blocking the user's access to the application, providing user a chance to recover the password, etc.

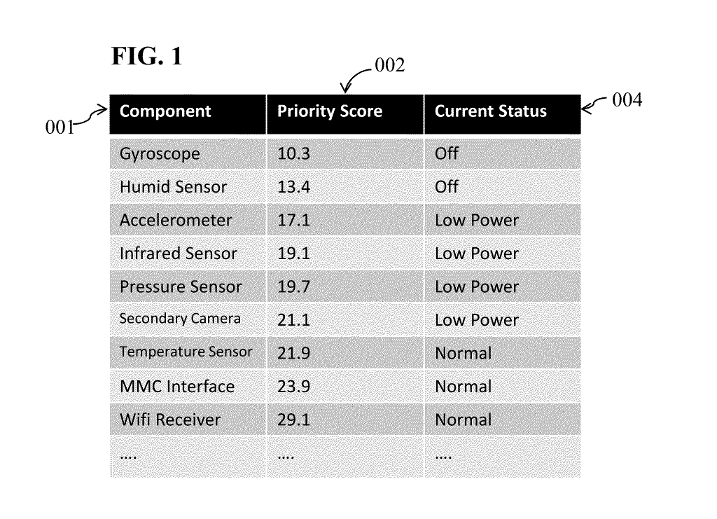

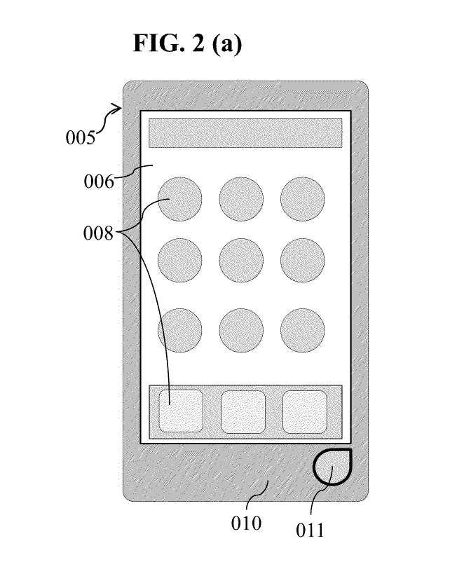

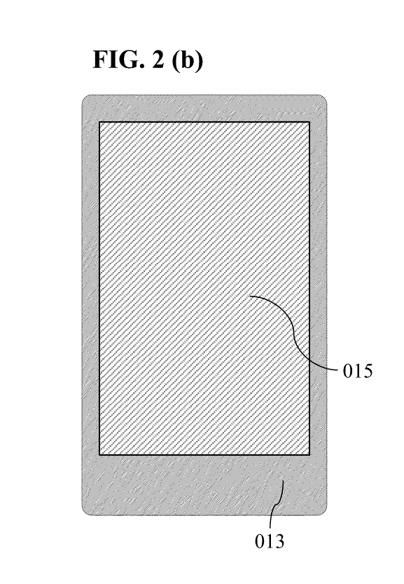

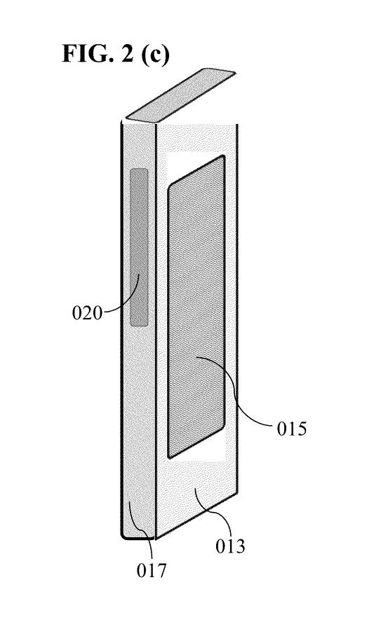

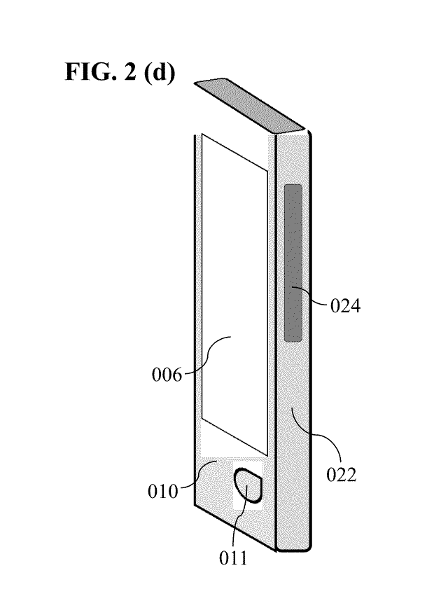

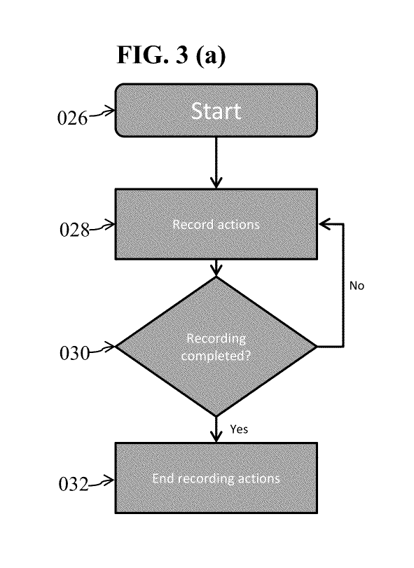

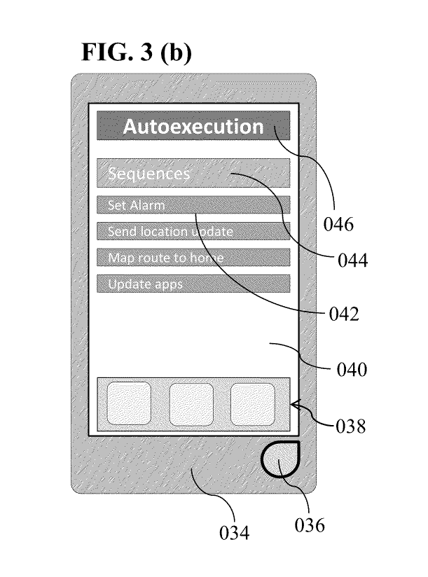

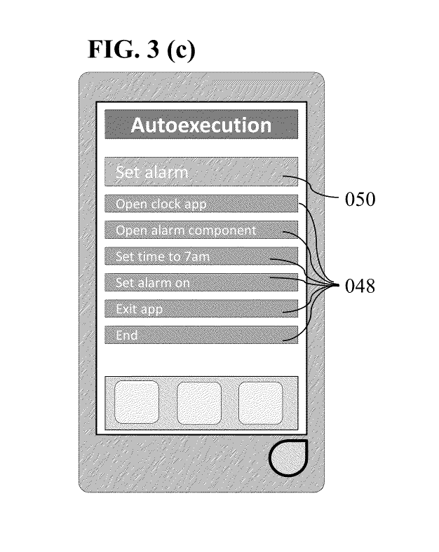

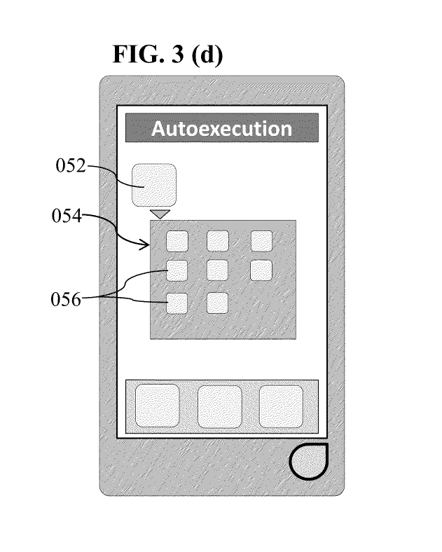

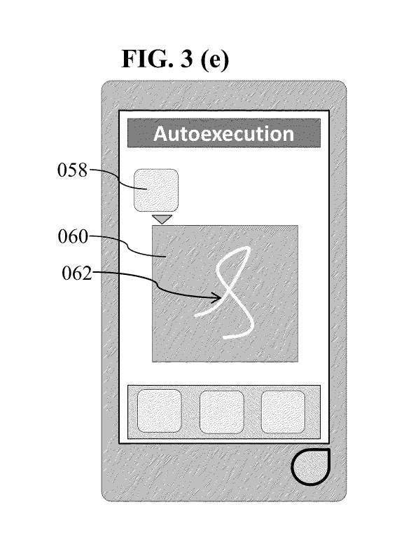

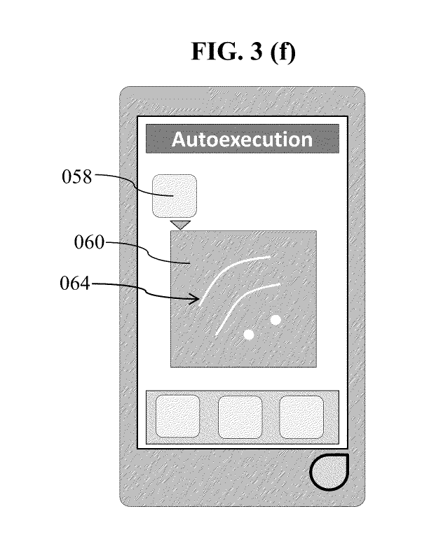

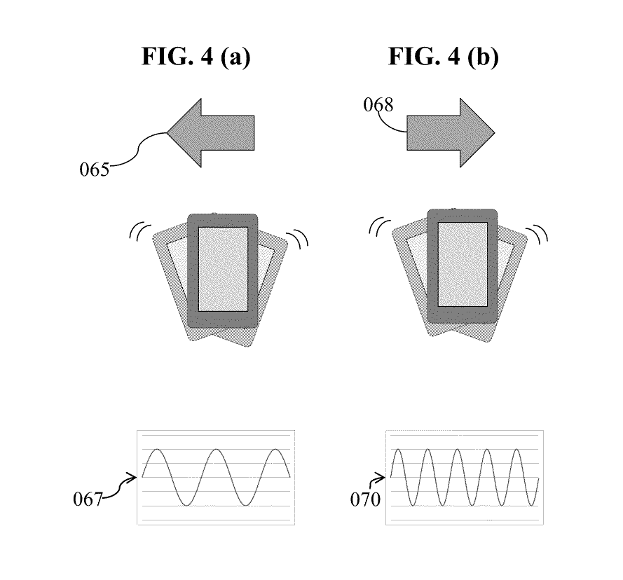

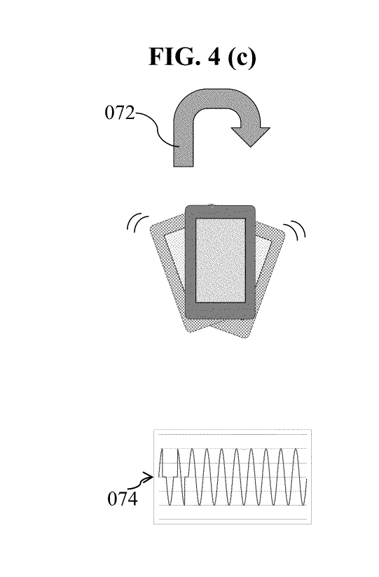

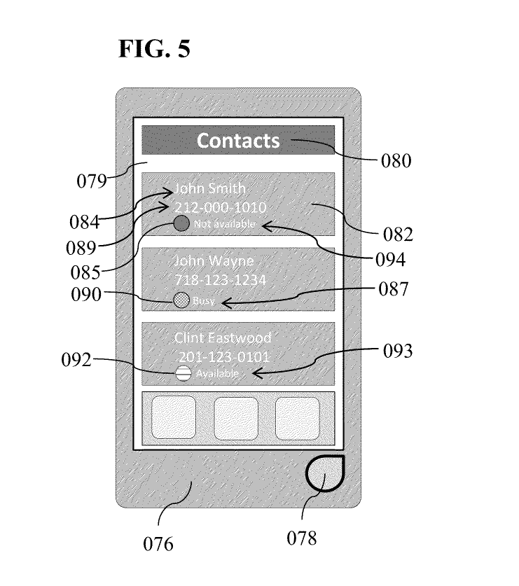

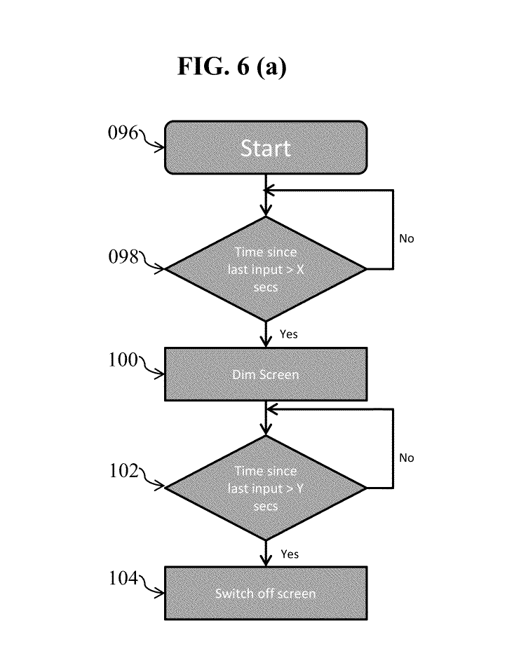

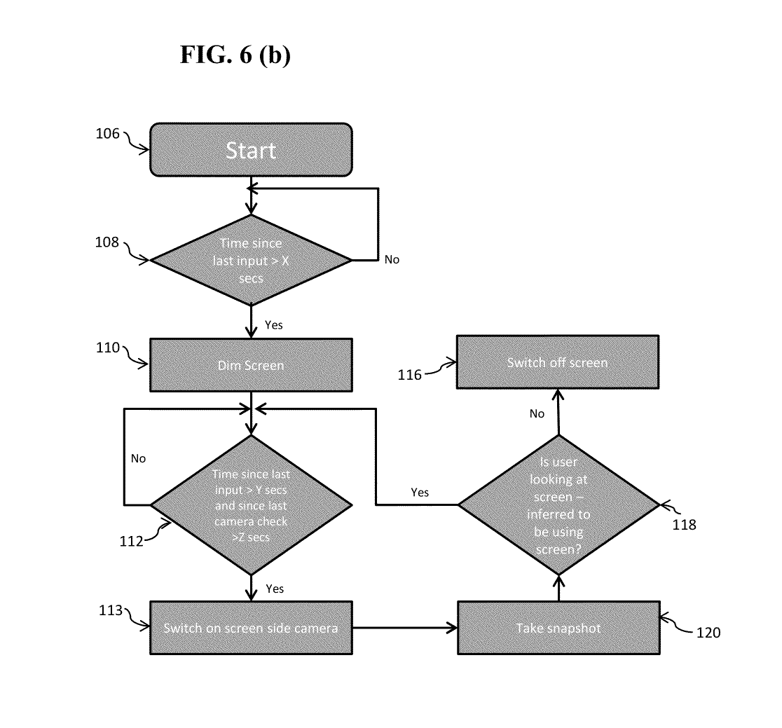

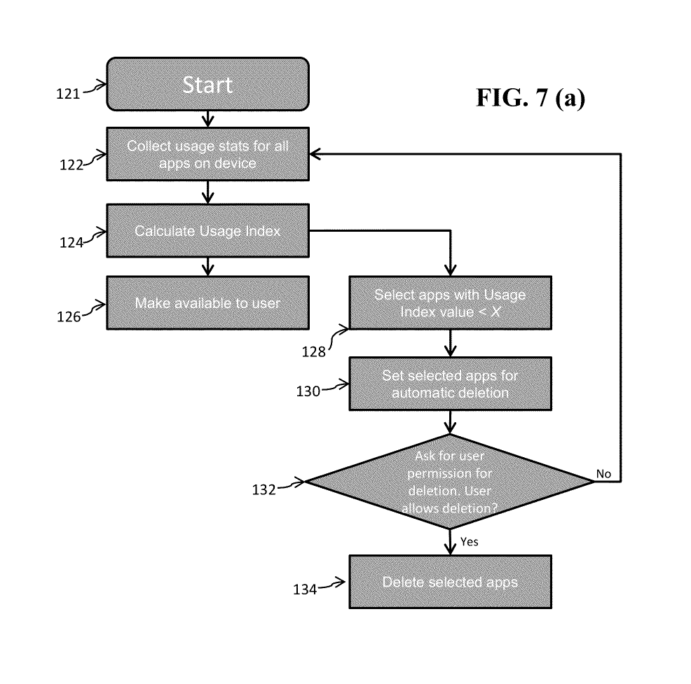

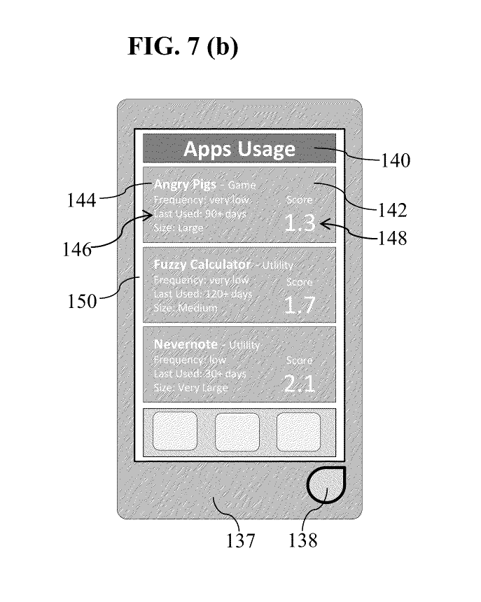

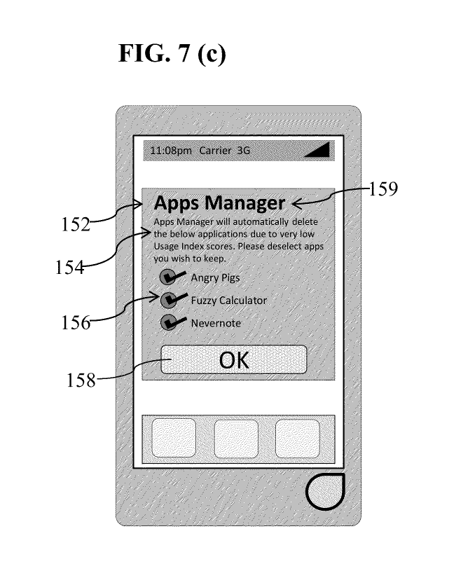

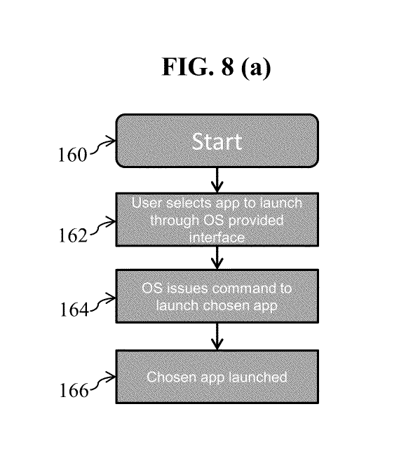

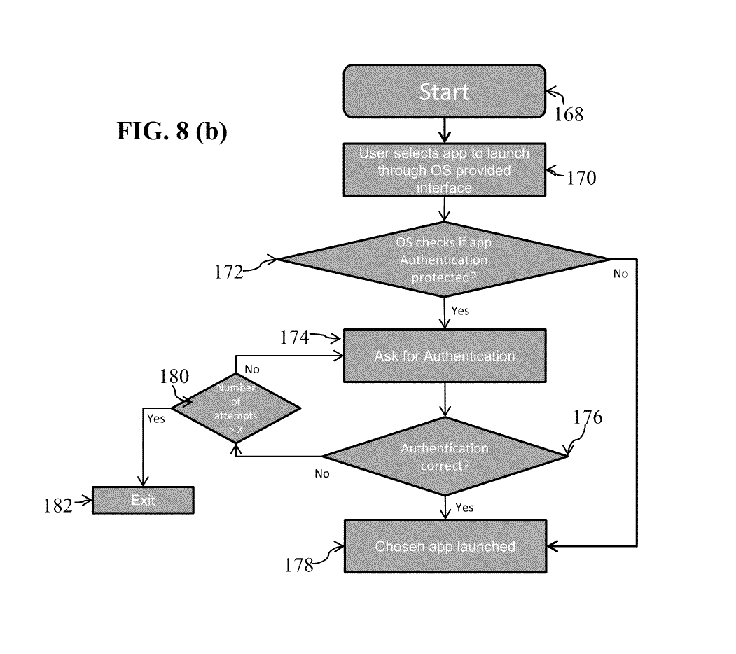

1. A system comprising:
a processor;
a computer readable non-transitory storage medium for tangibly storing thereon program logic for execution by the processor, the program logic comprising a method for managing a mobile electronic device when it is low on battery so as to switch the device to only the necessary functions and switch off all non-necessary functions, wherein a preset ordered list of components manually created by the user is used by the device as a guide for switching components off when the device battery is low on power.

2. A system comprising an apparatus wherein a touch interface is placed at the back of an electronic device and on its side edges to allow the user to input instructions to the device from the back surface and side surfaces of the device while simultaneously using the front side screen of the device.

3. A method of claim 2 wherein, this rear and side edge touch interfaces allow the user to control graphical elements on the front side screen.

4. A method of claim 2, wherein a graphical user interface element on the screen can help guide the user in the use of the back side and side edge touch interfaces by showing the current location of the user finger on the touch-sensitive side edge or rear touch surfaces.

5. A system comprising:
a processor;
a computer readable non-transitory storage medium for tangibly storing thereon program logic for execution by the processor, the program logic comprising a method for allowing the device to store a series of instructions at the operating system level, which it can automatically execute at a later time when instructed to do so.

6. A method of claim 5, wherein the user can record the series of instructions by issuing a specific instruction to the program logic to start recording the steps, then executing the required series of actions on the device, and then instructing the program logic to stop recording the steps.

7. A method of claim 5, wherein when the user issues a command for a previously stored series of instructions to be executed, the program logic automatically executes the instructions that were previously recorded, in sequence to achieve a desired end result for the user.

8. A method of claim 5, wherein the user may be provided with a graphical user interface which allows the user to record instructions for auto-execution at a later time, as well as later returning and finding the specific set of instructions he wants to execute, and issuing the command to execute the given instructions by interacting with some graphical user interface element provided by the program logic at the operating system level.

9. A method of claim 5, wherein the user can find previously recorded auto-execution instructions and edit them to change the set of instructions or their sequence or both.

10. A system comprising:
a processor;
a computer readable non-transitory storage medium for tangibly storing thereon program logic for execution by the processor, the program logic comprising a method to allow the user to execute a command by simply drawing a symbol on a section of the touch-sensitive interface of the device.

11. A method of claim 10 wherein the symbols may be predetermined or recorded by the user, and the program logic maps from the symbols to specific set of instructions to be executed.

12. A system comprising:
a processor;
a computer readable non-transitory storage medium for tangibly storing thereon program logic for execution by the processor, the program logic comprising a method for an intelligent wallpaper for mobile electronic devices which continuously changes its appearance based on the motion of the device or other sensor or data inputs, where the wallpaper is defined as the graphical user interface screen presented to the user when the device is not in active use but the device screen is on.

13. A system comprising:
a processor;
a computer readable non-transitory storage medium for tangibly storing thereon program logic for execution by the processor, the program logic comprising a method wherein navigational information is provided by a mapping application to the user by causing execution of distinct vibratory motions in the mobile electronic device.

14. A method of claim 13, wherein the program logic causes the mobile electronic device to execute different types of vibratory motion to signal different navigational actions, such as one vibratory motion for a left turn, another vibratory motion for a right turn, and another for a U-turn and so on, wherein the variations in the vibratory motions of the device may vary in various parameters such as frequency, amplitude, or component frequencies, so that each is clearly distinct from every other and can be easily distinguished by the user.

15. A system comprising:
a processor;
a computer readable non-transitory storage medium for tangibly storing thereon program logic for execution by the processor, the program logic comprising a method for providing users of phone networks the ability to communicate their availability status for phone calls to other users on the network so that other users on the network may know prior to placing the call if the user is available to talk on the phone or not (‘Call Status’).

16. A method of claim 15 wherein, the service works on the network level wherein the user can interact with the phone application on their device to set their call status, which is communicated over the phone networks to a central status management system, which in turn provides the caller's status to all other network users who request the user's Call Status.

17. A method of claim 15, wherein the users on the network can find the Call Status of other users on the network through their device by requesting the status through the phone application on their device or another application, which in turn may be displayed to them through a graphical user interface element on their device.

18. A system comprising:
a processor;
a computer readable non-transitory storage medium for tangibly storing thereon program logic for execution by the processor, the program logic comprising a method for controlling the lighting of a screen on the mobile device based on face recognition technology.

19. A method of claim 18, wherein the user facing camera of the electronic device is used to capture images of the user and facial recognition technology is utilized to determine if the user is reading the screen of the device or not by looking at various parameters such as whether the user's eyes are facing the screen or not.

20. A method of claim 18, wherein if the program logic determines the user to be reading the screen, it signals for the screen to be kept lighted up, and if it determines the user to not be using the screen, to switch off the screen or dim it.

21. A system comprising:
a processor;
a computer readable non-transitory storage medium for tangibly storing thereon program logic for execution by the processor, the program logic comprising a method for the operating system of the mobile electronic device to determine the usage statistics of the applications installed on the device and provide the information to the user.

22. A method of claim 21, wherein the usage information so collected may be information such as the frequency of use of applications, time duration of use of applications, last date of use of applications, among other parameters.

23. A method of claim 21, wherein the program logic automatically sets certain applications to be deleted when it determines that the application is not being used enough and notifies the user to permit the deletion, and when the user permits the deletion, the application is deleted from the device.

24. A method of claim 21, wherein the program logic provides a method for the user to view usage statistics for the applications installed on the device and carry out actions such as delete certain applications.

25. A method of claim 21, wherein the usage statistics of the applications installed on the device can be combined into a single number or indicator using an algorithm to convey the overall intensity of use of the application so that user or another service on the device can easily compare various applications in their respective intensity of use.

26. A system comprising:
a processor;
a computer readable non-transitory storage medium for tangibly storing thereon program logic for execution by the processor, the program logic comprising a method for allowing the operating system of the device to set restricted access for individual applications on the device independent of whether the application itself supports it or not.

27. A method of claim 26, wherein the program logic operates at the operating system level of the device, and could be used to restrict access to any application on the device, and may utilize for authentication various methods such as passwords, fingerprints, facial recognition etc.

28. A method of claim 26, wherein the program logic provides user interface methods which allow the user to select any installed application and request restricted access for it.

29. A method of claim 26, wherein if the installed application on the device is placed under restricted access by the user, the application cannot be run unless the authentication step is passed successfully by the user.
